(19) United States
(12) Patent Application Publication
(10) Pub. No.: US 2009/0301428 A1
(43) Pub. Date: Dec. 10, 2009

(54) CRANKSHAFT SET OF TWO-CYLINDER ENGINE EQUIPPED WITH FLYWHEEL

(75) Inventors: Byung Chul Lee, Suwon-city (KR); Soo Hong Lee, Seoul (KR); Jeyong Yun, Incheon (KR)

Correspondence Address: MORGAN, LEWIS & BOCKIUS LLP (SF), One Market, Spear Street Tower, Suite 2800, San Francisco, CA, 94105, US

(73) Assignees: Hyundai Motor Company, Seoul (KR); KIA MOTORS CORPORATION, Seoul (KR)

(21) Appl. No.: 12/274,095

(22) Filed: Nov. 19, 2008

(30) Foreign Application Priority Data
Jun. 4, 2008 (KR) 10-2008-0052785

(51) Int. Cl. F02B 75/32

(52) U.S. Cl. 123/197.4; 74/572.2

(57) ABSTRACT

A crankshaft set of a two-cylinder engine that is equipped with a flywheel may include a crankshaft that is mounted on an engine block, a first crank pin that is formed at one end of the crankshaft and is connected to a first piston through a connecting rod, a second crank pin that is formed at the other end of the crankshaft and is connected to a second crank pin through a connecting rod, and a flywheel that is disposed between the first and second crank pins and is integrally formed with the crankshaft. Accordingly, the twist and vibration characteristics are improved because the flywheel is disposed between the adjacent crank pins.

### CROSS-REFERENCE TO RELATED APPLICATION

The present application claims priority to Korean Patent Application Number 10-2008-0052785 filed Jun. 4, 2008, the entire contents of which application is incorporated herein for all purposes by this reference.

### BACKGROUND OF THE INVENTION

1. Field of the Invention

The present invention relates to a crankshaft set of a two-cylinder engine that is equipped with a flywheel, and more particularly to a flywheel that is mounted on a crankshaft and a crankshaft set of a two-cylinder engine including the flywheel.

2. Description of Related Art

Lately, vehicles that are equipped with two or three-cylinder engines have been launched for their light weight, fuel reduction, inexpensive price, etc.

The two-cylinder engine is advantageous in output or volume thereof, but the fluctuation rate of angular velocity is high compared with three or four-cylinder engines in view of the fact that the phase of the power stroke is 360°. Accordingly, a larger flywheel is to be disposed at the rear end portion of the crankshaft. Hence, there is a problem in which the mass center of the engine is moved to the flywheel.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a crankshaft set of a two-cylinder engine that is equipped with a flywheel having advantages of improving a vibration characteristic, wherein the mass center thereof is not biased to the flywheel.

A crankshaft set of a two-cylinder engine that is equipped with a flywheel may include a crankshaft that is mounted on an engine block, a first crank pin that is formed at one end of the crankshaft and is connected to a first piston through a first connecting rod, a second crank pin that is formed at the other end of the crankshaft and is connected to a second piston through a second connecting rod, and/or a flywheel that is formed between the first crank pin and the second crank pin in the crankshaft.

The flywheel may include a first member that is formed substantially at middle portion of the crankshaft, a second member that is formed apart from an exterior circumference of the first member, and/or a connecting member that connects the first member with the second member.

The flywheel may be substantially symmetric with respect to the connecting member in a longitudinal direction of the crankshaft.

The first and second members and/or the connecting member may have the same cross-section in a rotation direction.

Length of the second member may be larger than that of the connecting member and/or the first member in a longitudinal direction of the crankshaft so as to raise inertia mass of the flywheel.

The second member may be made up of a material whose density is larger than the first member.

A bearing may be disposed at the crankshaft to be adjacent to or contact one side surface of the first member, and the bearing supports the crankshaft.

A pair of bearings may be disposed at the crankshaft to be adjacent to or contact both side surfaces of the first member, and the pair of bearings support the crankshaft.

Rotation center and mass center of the flywheel may be the same as rotation center of the crankshaft.

The flywheel may be integrally formed with the crankshaft.

The first and second crank pins may have the same rotation position in the crankshaft.

A first counterweight may be disposed at an opposite side to the first crank pin, and a second counterweight may be disposed at an opposite side to the second crank pin.

The first counterweight and the first crank pin may have approximately 180° rotation position therebetween.

The second counterweight and the second crank pin may have approximately 180° rotation position therebetween.

The first counterweight and first crank pin may be substantially symmetrically disposed with the second counterweight and second crank pin with respect to a center portion of the flywheel in a longitudinal direction of the crankshaft.

The flywheel may be disposed in the middle of a cylinder, and length of the flywheel that is extended in a longitudinal direction of the crankshaft is shorter than the interior diameter of the cylinder so as to be disposed inside the cylinder.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a front view of an exemplary crankshaft that is equipped with a flywheel according to the present invention.

FIG. 2 is a cross-sectional perspective view of an exemplary crankshaft that is equipped with a flywheel according to the present invention.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

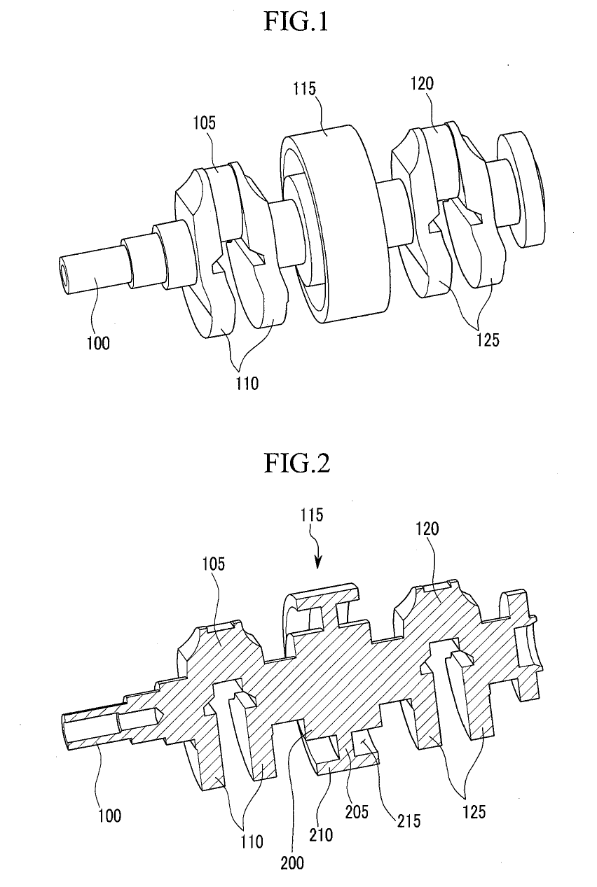

FIG. 1 is a front view of a crankshaft that is equipped with a flywheel according to various embodiments of the present invention.

Referring to FIG. 1, a crankshaft of a two-cylinder engine that is equipped with a flywheel includes a crankshaft 100, a first crank pin 105, a first counterweight 110, a flywheel 115, a second crank pin 120, and a second counterweight 125.

The crank pins 105 and 120 are respectively connected to connecting rods wherein the crank pins 105 and 120 are integrally formed with the crankshaft 100 and can be made up of a separate shaft (pin). In various embodiments, the crank pins may be monolithically formed with the crankshaft.

The first crank pin 105 and the second crank pin 120 are disposed at respective ends of the crankshaft 100, and the flywheel 115 is disposed between the first crank pin 105 and the second crank pin 120.

The flywheel 115 is integrally formed with the crankshaft 100 and efficiently absorbs vibration that is generated from the crankshaft 100. Similarly, in various embodiments, the flywheel may be monolithically formed with the crankshaft.

The first crank pin 105 and the second crank pin 120 that rotate together with the crankshaft 100 have the same rotation position as each other, the first counterweight 110 is disposed at an opposite side to that of the first crank pin 105, and the second counterweight 125 is disposed at an opposite side to that of the second crank pin 120.

The first and second crank pins 105 and 120 and the first and second counterweights 110 and 125 are disposed at opposite directions from each other and absorb rotation vibration or reciprocation vibration. Also, the first and second counterweights 110 and 125 are respectively disposed at both sides of the first and second crank pins 105 and 120 to absorb vibration.

In various embodiments of the present invention, the flywheel 115 is disposed between the first and second crank pins 105 and 120 to effectively absorb vibration.

When the flywheel 115 is mounted on only one end portion of the crankshaft 100, twist stress is generated on the crankshaft 100, and there is a problem in that vibration increases at the other end portion at which the flywheel 115 is not disposed.

In various embodiments of the present invention, the first crank pin 105 is connected to a first piston by a connecting rod and the second crank pin 120 is connected to a second piston by a connecting rod.

Also, in various embodiments of the present invention, a third crank pin can be disposed instead of the flywheel 115, and in this case, the third crank pin can be disposed at an opposite side of the first and second crank pins 105 and 120 with a rotation difference of 180° from them. When the third crank pin is disposed, it can be applied to a three-cylinder engine.

FIG. 2 is a cross-sectional perspective view of a crankshaft that is equipped with a flywheel according to various embodiments of the present invention.

Referring to FIG. 2, the flywheel will be explained. As shown, the flywheel 115 includes a first member 200, a second member 210, and a connecting member 205.

The first member 200 is formed at the center portion of the crankshaft 100, and the second member 210 is formed with a predetermined gap from an exterior circumference of the first member 200 and is formed as a ring. Also, the connecting member 205 is formed between the first member 200 and the second member 210.

The first member 200, the second member 210, and the connecting member 205 can be integrally formed with the crankshaft 100. Similarly, in various embodiments, the connecting member may be monolithically formed with the crankshaft.

Further, the density and the volume of the second member 210 can be increased so as to increase the rotational inertia mass of the flywheel 115. Accordingly, it is desirable that the second member 210 is formed in a longitudinal direction of the crankshaft 100.

As shown, the length of the second member 210 is greater than that of the connecting member 205 in a longitudinal direction of the crankshaft 100. Accordingly, a groove 215 is formed between the first member 200, the second member 210, and the connecting member 205. The groove 215 can be formed continuously or at intervals in a rotation direction of the crankshaft.

Further, the first member 200, the second member 210, and the connecting member 205 have the same cross-section in a rotation direction of the crankshaft 100, and the mass center and the rotation center thereof are equal to those of the crankshaft 100.

So as to support the crankshaft 100, support bearings can be respectively disposed between the first crank pin 105 and the flywheel 115, and between the second crank pin 120 and the flywheel 115. Herein, the first member 200 contacts the side surface of the support bearing to be securely supported.

Referring to FIG. 2, the flywheel 115 is disposed in the middle of the bore of a cylinder and the length of the flywheel in a longitudinal direction of the crankshaft 100 can be shorter than the interior diameter of the bore of the cylinder. Accordingly, the flywheel 115 can be disposed at the inside of the bore of the cylinder.

According to various aspects of the present invention, the twist characteristic is improved because the flywheel is disposed between the adjacent crank pins, wherein the weight of the engine is not biased to one side thereof.

Further, the vibration characteristic is improved because the flywheel is disposed between the adjacent crank pins.

For convenience in explanation and accurate definition in the appended claims, the terms “front” or “rear”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A crankshaft set of a two-cylinder engine comprising;
a crankshaft that is mounted on an engine block;
a first crank pin that is formed at one end of the crankshaft and is connected to a first piston through a first connecting rod;
a second crank pin that is formed at the other end of the crankshaft and is connected to a second piston through a second connecting rod; and
a flywheel that is formed between the first crank pin and the second crank pin in the crankshaft.

2. The crankshaft set of claim 1, wherein the flywheel includes:
a first member that is formed substantially at middle portion of the crankshaft;
a second member that is formed apart from an exterior circumference of the first member; and
a connecting member that connects the first member with the second member.

3. The crankshaft set of claim 2, wherein the flywheel is substantially symmetric with respect to the connecting member in a longitudinal direction of the crankshaft.

4. The crankshaft set of claim 2, wherein the first and second members and/or the connecting member has the same cross-section in a rotation direction.

5. The crankshaft set of claim 2, wherein length of the second member is larger than that of the connecting member and/or the first member in a longitudinal direction of the crankshaft so as to raise inertia mass of the flywheel.

6. The crankshaft set of claim 2, wherein the second member is made up of a material whose density is larger than the first member.

7. The crankshaft set of claim 2, wherein a bearing is disposed at the crankshaft to be adjacent to or contact one side surface of the first member, and the bearing supports the crankshaft.

8. The crankshaft set of claim 2, wherein a pair of bearings are disposed at the crankshaft to be adjacent to or contact both side surfaces of the first member, and the pair of bearings support the crankshaft.

9. The crankshaft set of claim 1, wherein rotation center and mass center of the flywheel are the same as rotation center of the crankshaft.

10. The crankshaft set of claim 1, wherein the flywheel is integrally formed with the crankshaft.

11. The crankshaft set of claim 1, wherein the first and second crank pins have the same rotation position in the crankshaft.

12. The crankshaft set of claim 1, wherein a first counterweight is disposed at an opposite side to the first crank pin, and a second counterweight is disposed at an opposite side to the second crank pin.

13. The crankshaft set of claim 12, wherein the first counterweight and the first crank pin has approximately 180° rotation position therebetween.

14. The crankshaft set of claim 12, wherein the second counterweight and the second crank pin has approximately 180° rotation position therebetween.

15. The crankshaft set of claim 12, wherein the first counterweight and first crank pin are substantially symmetrically disposed with the second counterweight and second crank pin with respect to a center portion of the flywheel in a longitudinal direction of the crankshaft.

16. The crankshaft set of claim 1, wherein the flywheel is disposed in the middle of a cylinder, and length of the flywheel that is extended in a longitudinal direction of the crankshaft is shorter than the interior diameter of the cylinder so as to be disposed inside the cylinder.

17. A two-cylinder engine comprising the crankshaft set of claim 1.

18. A passenger vehicle comprising the two-cylinder engine of claim 17.
